(19) United States
(12) Patent Application Publication
(10) Pub. No.: US 2007/0255625 A1
(43) Pub. Date: Nov. 1, 2007

(54) Software-based method for facilitating the selling of real estate on the internet

(76) Inventor: Bryant E. Katzen, San Diego, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/405,810

(22) Filed: Apr. 17, 2006

(51) Int. Cl. G06Q 30/00

(52) U.S. Cl. 705/26

(57) ABSTRACT

A method to permit penetration of the traditional and “For Sale By Owner” real estate market by providing a secure online “Transaction Management” solution that seamlessly integrates all the functions of the real estate transaction process, including all functions of the buying, selling, leasing process. It permits simultaneously managing, tracking and collaborating among all parties to the transaction while eliminating the need for real estate broker's by bringing buyers and seller together to create an efficient, cost effective and secure virtual real estate transaction platform. The present invention permits buyers, sellers and all authorized parties to the transaction to seamlessly communicate; upload any transactional documents at any time with secure access; track who has viewed or signed documents with real time access; automate calendaring and action plans; electronically sign any necessary documents; allow third party companies such as escrow, title and lenders permission to view, exchange, or upload critical information pertaining to the transaction at any time.

### BACKGROUND OF THE INVENTION

1. Field of the Invention

The present invention relates generally to a method of selling real estate. The invention relates more specifically to a software-based real estate selling process.

2. Background Art

Traditional real estate transaction procedures are outdated, time consuming and cost the average homeowner a significant portion of the proceeds of the sale.

Applicant knows of no software solutions which provide homeowners with ability to seamlessly sell their homes. The present invention incorporates all functions of the real estate transaction for “For Sale By Owners.”

U.S. published patent application 2005/0288955 discloses an automated system which allows the transmission of real estate transaction-related data to service providers such as mortgage lenders, contractors and inspectors. This invention is not designed to facilitate sale by owners and does not obviate the services of real estate professionals.

U.S. published patent application 2004/0143450 discloses what is primarily a message system for a wide network of real estate offerings and still involves the use of professional real estate agents as essential personnel.

U.S. published patent application 2004/0088181 discloses a data sharing system for real estate transactions. This system is primarily a secure document transfer-oriented network, but does not provide all of the necessary steps for a buyer and seller to complete a real estate transaction without third party professionals.

### SUMMARY OF THE INVENTION

A principal object of the present invention is to provide a method to permit penetration of the traditional and “For Sale By Owner” real estate market by providing a secure online “Transaction Management” solution that seamlessly integrates all the functions of the real estate transaction process, including all functions of the buying, selling, leasing process. It permits simultaneously managing, tracking and collaborating among all parties to the transaction while eliminating the need for real estate broker's by bringing buyers and seller together to create an efficient, cost effective and secure virtual real estate transaction platform.

The preferred embodiment of the present invention permits buyers, sellers and all authorized parties to the transaction to seamlessly communicate; upload any transactional documents at any time with secure access; track who has viewed or signed documents with real time access; automate calendaring and action plans; electronically sign any necessary documents; allow third party companies such as escrow, title and lenders permission to view, exchange, or upload critical information pertaining to the transaction at any time, day or night, seven days a week, fifty two weeks a year.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIGS. 1a, 1b and 1c together provide a sequential flow chart illustration of a preferred embodiment of the invention.

### DETAILED DESCRIPTION OF A PREFERRED EMBODIMENT

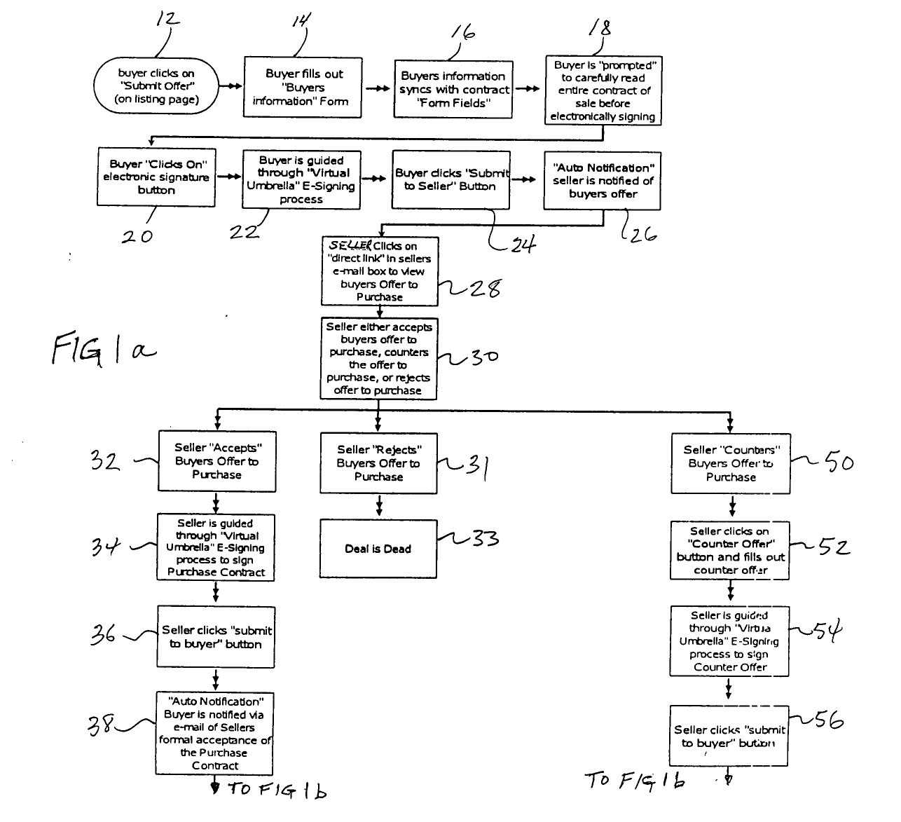

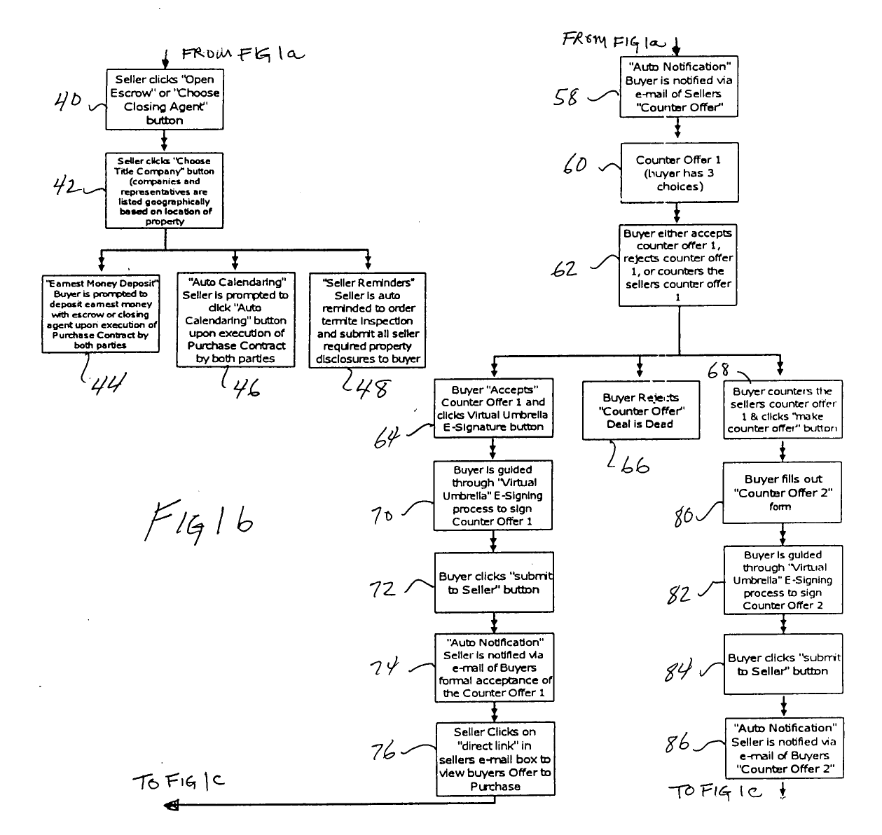

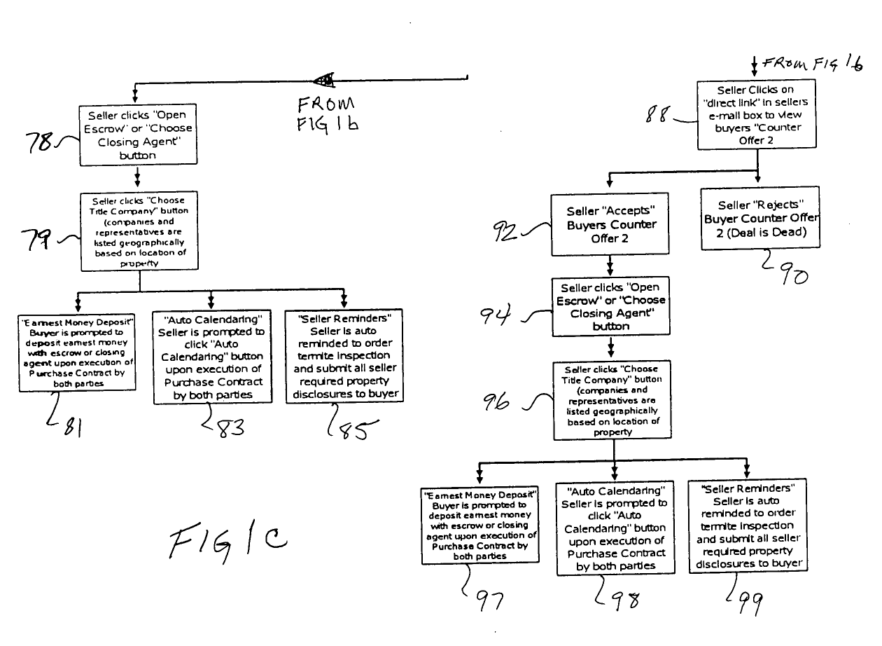

A preferred embodiment of the invention herein is illustrated in a flow chart format in FIGS. 1a, 1b and 1c which together in sequence provide an illustrative description.

All steps within the flow chart, with exception of step 12, take place within the virtual transaction platform of the preferred embodiment.

The first step in the online transaction process begins when the buyer's decides to purchase the home listed for sale on a known web site. The buyer's searches for homes on the know web site and on each home listing page there is a “Submit Offer” button that the buyer will click on when they choose to make on offer to purchase the home. Once they have clicked on the “Submit Offer” button the buyer will be taken to the next step called “Buyers Information”

The buyer's information page consists of a form field that requires the buyer's to fill in the required information that is necessary to complete the “Offer to Purchase”

The following detailed information will be required in step 14: Buyer's Name/s; County; Address; Legal Description; Date of Execution; Items Included in Sale; Sales Price; Earnest Money; New Loan; Assumption of Loan; Seller Financing; Cash at Closing; Closing Date; Title Insurance, Escrow/Closing Fees; Appraisal; Termite Inspection; Other Closing Costs; Contingency Removal Periods and Dates. Once all information required is properly filled in, the buyer's will click “Submit or Sync”

Information from Step 14 will be automatically filled into (or “synced”) into the CONTRACT FOR SALE AND PURCHASE OF REAL ESTATE in step 16.

Before buyer(s) is authorized to electronically sign, print, or save document; buyer will be prompted to carefully read the entire contract of sale in step 18 before moving to Step 20. This will help ensure the buyer's understand the contract in its entirety.

Buyer will click on icon labeled “Electronic Signature” in step 20. Once buyer clicks on the electronic signature icon the buyer will be taken to the next step; Virtual Umbrella E-Signature process in step 22.

Buyer will either login to Virtual Umbrella E-Signature or create a login for first time users. Once logged in, the buyer will follow the necessary steps to electronically sign all documents.

After all documents are signed, buyer will click “Submit to Seller” button in step 24 located within the Virtual Umbrella Platform.

Auto Notification in step 26—Seller is immediately notified of buyer's Fully Executed CONTRACT FOR SALE AND PURCHASE OF REAL ESTATE through email.

The auto notification sent to the Seller through email contains a direct link to the buyers CONTRACT OF SALE AND PURCHASE OF REAL ESTATE. Seller can then click on the direct link in step 28 to be directed to the Buyers CONTRACT FOR SALE AND PURCHASE OF REAL ESTATE; Giving the seller immediate access to review the contract.

Seller in step 30 has three choices: Accept Buyers Offer, Counter the offer, reject the offer. If Seller Accepts Buyer's offer then they move on to steps 32-48. If Seller rejects Buyer's offer then the deal is dead as shown in steps 31 and 33. If the Seller counters Buyer's offer then they move on to steps 50-62.

Seller clicks on “Accept Buyer's Offer” in step 32 and then is directed to the Virtual Umbrella E-Signing process.

Once Seller is logged into the Virtual Umbrella E-Signing process, the Seller will follow the necessary steps to electronically sign all documents as shown in step 34.

After all documents are signed, Seller will click “Submit to Buyer” button in step 36 located within the Virtual Umbrella Platform.

Auto Notification step 38—Buyer is immediately notified of Seller's formal acceptance of the Fully Executed CONTRACT FOR SALE AND PURCHASE OF REAL ESTATE through email.

Seller then in step 40 either clicks “Open Escrow or “Choose Closing Agent” icon (Some states have escrow companies and some states use closing agents or Attorney's) Once Seller chooses one or the other, Companies and representatives will be listed geographically based on location of property. Seller is prompted to choose one and call or email to open up escrow as shown in step 42.

Seller clicks “Choose Title Company” icon. Companies and representatives will be listed geographically based on location of property. Seller is prompted is call or email to open up title.

Once Escrow and Title have been opened by the Seller, the buyer will be “Auto Notified,” via email to deposit the agreed Earnest Money Deposit with escrow or the closing agent in step 44.

In step 46 “Auto Calendaring” Seller is prompted to click “Auto Calendaring” icon upon execution of CONTRACT FOR SALE AND PURCHASE OF REAL ESTATE and opening of escrow and title. Auto Calendaring syncs all contingency removal periods from the contract into the calendar so all parties are aware of the important time periods and contingency removal dates.

In step 48 “Seller Reminder” Seller is Auto Notified to order termite inspection, home warranty protection plan, HOA documents, and submit all Seller required and state mandated property disclosures to buyer.

Seller may alternatively choose to counter Buyer's CONTRACT FOR SALE AND PURCHASE OF REAL ESTATE in step 50.

In Step 52 Seller clicks “Counter Offer” icon and the counter offer immediately uploads into the Virtual Umbrella Platform, allowing the Seller to complete the counter offer.

In step 54 Seller will click on icon labeled “Electronic Signature” Once Seller clicks on electronic signature icon the Seller will be guided through the Virtual Umbrella E-Signature process.

After all documents are signed, Seller will click “Submit to Buyer” icon; located within the Virtual Umbrella Platform in step 56.

In step 58 Auto Notification—Buyer is immediately notified of Seller's Counter Offer through email. The auto notification sent to the Buyer through email contains a direct link to the Seller's COUNTER OFFER. Buyer can then click on the direct link to be directed to the Seller's COUNTER OFFER; Giving the seller immediate access to review the contract.

COUNTER OFFER 1—Buyer has 3 choices as illustrated in steps 64, 66 and 68.

Buyers either accepts Seller's COUNTER OFFER, Counters the Seller's COUNTER OFFER, OR reject the Seller's COUNTER OFFER. If Buyer accepts Sellers COUNTER OFFER then they move on to steps 70-79. If Buyer rejects Seller's COUNTER OFFER then the deal is dead as shown in step 66. If the Buyer Counters the Seller's COUNTER OFFER then they move on to steps 80-86

If Buyer clicks on “Accept Seller's COUNTER OFFER” and he is directed to the Virtual Umbrella E-Signing process in step 70.

Once Buyer is logged into the Virtual Umbrella E-Signing process, the Buyer will follow the necessary steps to electronically sign all documents.

After all documents are signed, Buyer will click “Submit to Seller” icon in step 72; located within the Virtual Umbrella Platform

In step 74 Auto Notification—Seller is immediately notified of Buyer's formal acceptance of the Fully Executed COUNTER OFFER through email.

In step 76 Seller then clicks on the direct link to be directed to the Fully Executed COUNTER OFFER; Giving the seller immediate access to review the COUNTER OFFER.

In step 78 Seller either clicks “Open Escrow or “Choose Closing Agent” icon (Some states have escrow companies and some states use closing agents or Attorney's) Once Seller chooses one or the other, Companies and representatives will be listed geographically based on location of property. Seller is prompted to choose one and call or email to open up escrow.

In step 79 Seller clicks “Choose Title Company” icon. Companies and representatives will be listed geographically based on location of property. Seller is prompted is call or email to open up title.

Once Escrow and Title have been opened by the Seller, the buyer will be “Auto Notified,” via email to deposit the agreed Earnest Money Deposit with escrow or the closing agent as shown in step 81.

In step 83 “Auto Calendaring” Seller is prompted to click “Auto Calendaring” icon upon execution of CONTRACT FOR SALE AND PURCHASE OF REAL ESTATE and opening of escrow and title. Auto Calendaring syncs all contingency removal periods from the contract into the calendar so all parties are aware of the important time periods and contingency removal dates.

In step 85 “Seller Reminder” Seller is Auto Notified to order termite inspection, home warranty protection plan, HOA documents, and submit all Seller required and state mandated property disclosures to buyer.

If Buyer chooses to counter Seller's COUNTER OFFER #1 in step 68, Buyer clicks “Counter Offer” icon and the counter offer immediately uploads into the Virtual Umbrella Platform, allowing the Buyer to complete COUNTER OFFER #2 in step 80.

In step 82 Buyer will click on icon labeled “Electronic Signature” Once Buyer clicks on electronic signature icon the Buyer will be guided through the Virtual Umbrella E-Signature process.

In step 84 after all documents are signed, Buyer will click “Submit to Seller” icon; located within the Virtual Umbrella Platform.

In step 86 Auto Notification—Seller is immediately notified of Buyer's COUNTER OFFER #2 through email.

The auto notification sent to the Seller through email contains a direct link to the Buyer's COUNTER OFFER #2. In step 88 Seller can then click on the direct link to be directed to the Buyer's COUNTER OFFER #2; Giving the seller immediate access to review the contract.

At this point the Seller has 2 choices; to accept the Buyer's COUNTER OFFER #2 OR reject the COUNTER OFFER #2 and kill the deal as shown in step 90. If Seller Accepts COUNTER OFFER #2 then Seller moves on to Steps 92-99.

In step 92 Seller clicks on “Accept Buyer's COUNTER OFFER #2” and then is directed to the Virtual Umbrella E-Signing process.

Once Seller is logged into the Virtual Umbrella E-Signing process, the Seller will follow the necessary steps to electronically sign all documents.

After all documents are signed, Seller will click “Submit to Buyer” icon; located within the Virtual Umbrella Platform.

Auto Notification—Buyer is immediately notified of Seller's formal acceptance of the Fully Executed COUNTER OFFER # 2 through email.

In step 94 Seller either clicks “Open Escrow or “Choose Closing Agent” icon (Some states have escrow companies and some states use closing agents or Attorney's) Once Seller chooses one or the other, Companies and representatives will be listed geographically based on location of property. Seller is prompted to choose one and call or email to open up escrow.

In step 96 Seller clicks “Choose Title Company” icon. Companies and representatives will be listed geographically based on location of property. Seller is prompted is call or email to open up title.

In step 97 once Escrow and Title have been opened by the Seller, the buyer will be “Auto Notified,” via email to deposit the agreed Earnest Money Deposit with escrow or the closing agent.

In step 98 “Auto Calendaring” Seller is prompted to click “Auto Calendaring” icon upon execution of CONTRACT FOR SALE AND PURCHASE OF REAL ESTATE and opening of escrow and title. Auto Calendaring syncs all contingency removal periods from the contract into the calendar so all parties are aware of the important time periods and contingency removal dates.

In step 99 “Seller Reminder” Seller is Auto Notified to order termite inspection, home warranty protection plan, HOA documents, and submit all Seller required and state mandated property disclosures to buyer.

It will now be understood that the method of the present invention provides a seller of a real estate property a vehicle for offering the property and negotiating the terms of the sale with a prospective buyer until a mutual agreement is completed to the point of signatures. It will also be understood that although a preferred embodiment has been disclosed herein, various additions and modifications may be readily incorporated in the disclosed method. By way of example, it is clearly within the contemplated method to provide additional opportunities for further counter offer stages for seller and buyers. Therefore, the invention is limited only by the appended claims and their equivalents.

I claim:

1. A method for facilitating the sale of real estate over the Internet; the method comprising the steps of:
a) providing a web site listing of a seller's real estate property including an input for buyers to submit an offer;
b) presenting a form for buyers to submit an electronically signed offer to buy said property and automatically submitting said offer to the seller by e-mail;
c) allowing seller to accept the buyer's offer, reject the buyer's offer or make a counter-offer to buyer;
d) if seller accepts buyer's offer, permitting seller to electronically execute a purchase contract based on buyer's offer and automatically notifying buyer of seller's acceptance;
e) if seller counters buyer's offer, automatically notifying buyer of seller's counter-offer by e-mail;
f) allowing buyer to accept seller's counter-offer, reject the seller's counter-offer or make a counter-counter-offer to seller;
g) if buyer accepts seller's counter-offer, permitting buyer to electronically execute a purchase contract based on seller's counter-offer and automatically notifying seller of buyer's acceptance;
h) if buyer counters the seller's counter-offer, automatically notifying seller of buyer's counter-counter-offer by e-mail;
i) allowing seller to either reject buyer's counter-counter-offer or accept it; and
j) if seller accepts buyer's counter-counter-offer, permitting seller to electronically execute a purchase contract based on buyer's counter-counter-offer and automatically notifying buyer of seller's acceptance.

2. The method recited in claim 1, the method further comprising in the event of an acceptance of an offer, the steps of allowing seller to automatically open escrow or choose a closing agent, choosing a title company and automatically calendaring important time periods and dates.

3. A method for facilitating the sale of real estate by a property owner to prospective buyers over the Internet; the method comprising the steps of:
a) providing a web site listing of a seller's real estate property including an input for buyers to submit an offer;
b) presenting a form for buyers to submit an electronically signed offer to buy said property and automatically submitting said offer to the seller by e-mail;
c) allowing seller to accept the buyer's offer, reject the buyer's offer or make a counter-offer to buyer;
d) if seller accepts buyer's offer, permitting seller to electronically execute a purchase contract based on buyer's offer and automatically notifying buyer of seller's acceptance.

4. The method recited in claim 3 further comprising the steps of:
e) if seller counters buyer's offer, automatically notifying buyer of seller's counter-offer by e-mail;
f) allowing buyer to accept seller's counter-offer, reject the seller's counter-offer or make a counter-counter-offer to seller;
g) if buyer accepts seller's counter-offer, permitting buyer to electronically execute a purchase contract based on seller's counter-offer and automatically notifying seller of buyer's acceptance.

5. The method recited in claim 3, the method further comprising in the event of an acceptance of an offer, the steps of allowing seller to automatically open escrow or choose a closing agent, choosing a title company and automatically calendaring important time periods and dates.

6. The method recited in claim 4, the method further comprising in the event of an acceptance of an offer, the steps of allowing seller to automatically open escrow or choose a closing agent, choosing a title company and automatically calendaring important time periods and dates.
